(19) United States
(12) Patent Application Publication
(10) Pub. No.: US 2024/0389574 A1
(43) Pub. Date: Nov. 28, 2024

(54) SYSTEMS AND METHODS FOR ENHANCING LOCATION OF GAME IN THE FIELD

(71) Applicant: Joe Morgan, Columbus, MS (US)

(72) Inventor: Joe Morgan, Columbus, MS (US)

(21) Appl. No.: 18/376,343

(22) Filed: Oct. 3, 2023

Related U.S. Application Data
(63) Continuation-in-part of application No. 17/226,836, filed on Apr. 9, 2021, now Pat. No. 11,774,540.

(51) Int. Cl. A01M 31/00; G01S 3/808; H04R 1/40

(52) U.S. Cl. CPC A01M 31/002; G01S 3/8083; H04R 1/406

(57) ABSTRACT

A sound detection system of the present disclosure has at least one sound detection device for placement in an environment to detect sounds in the environment. Further, the system has at least one handheld device that receives data indicative of a sound in the environment detected by the sound detection device and a processor that identifies the sound and notifies an operator of the handheld device what produced the sound.

### CROSS-REFERENCE TO RELATED APPLICATIONS

This application in a continuation-in-part and claims priority to U.S. patent application Ser. No. 17/226,836 entitled Systems and Methods of Enhancing Game in the Field and filed on Apr. 9, 2021, which is incorporated herein by reference.

### BACKGROUND

A hunter uses different senses when hunting prey. The hunter may hunt prey, including but not limited to deer, turkey, etc. In hunting the prey, the hunter uses his sight to see broken branches that may indicate prey is close. Further, the hunter may use his sense of sight to see the prey before shooting. The hunter may use his sense of smell to detect waste matter and follow a trail. Also, the hunter may use his sense of hearing to locate prey.

Some hunters lack the sense of hearing necessary to hear prey. In such a scenario, it makes it extremely difficult to locate prey in a wooded area or any other area where prey may be found.

### DETAILED DESCRIPTION OF DRAWINGS

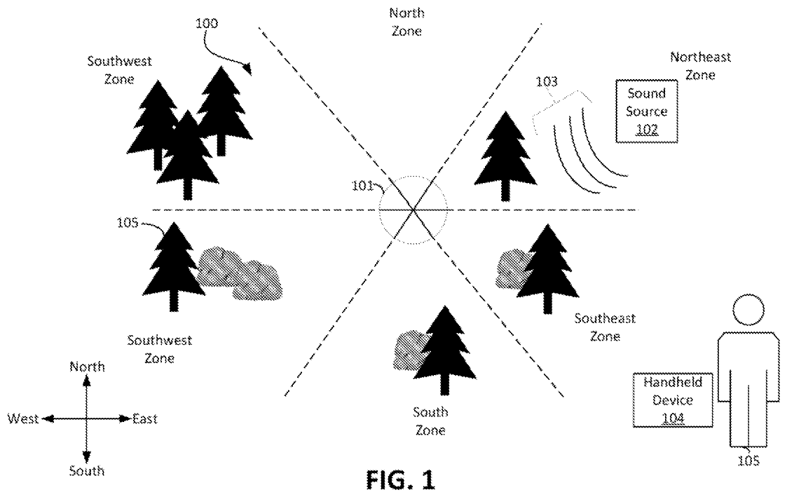

FIG. 1 is a block diagram of a system for enhancing location of game in the field in accordance with an embodiment of the present disclosure.

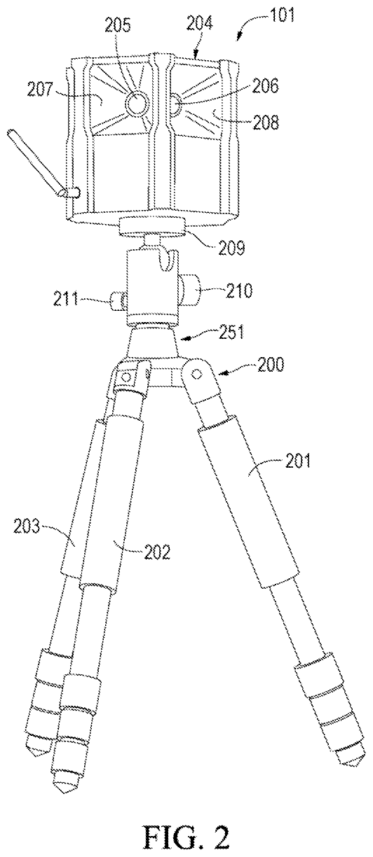

FIG. 2 is an exemplary sound detector as is shown in FIG. 1.

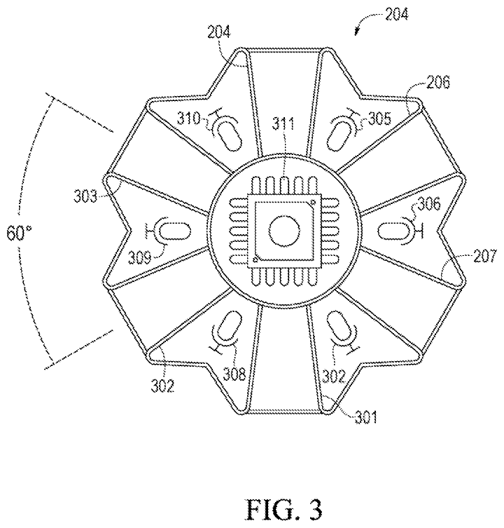

FIG. 3 is a cross-sectional view of a head of the sound detector such as is shown in FIG. 2.

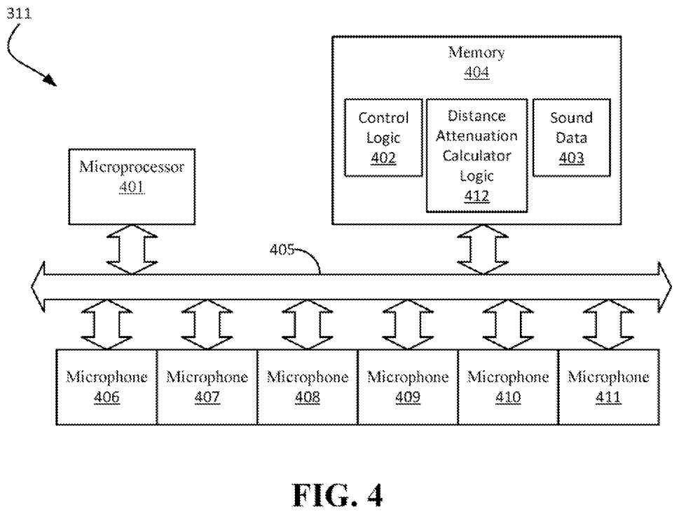

FIG. 4 is an exemplary microcontroller of the sound detector such as is shown in FIG. 2.

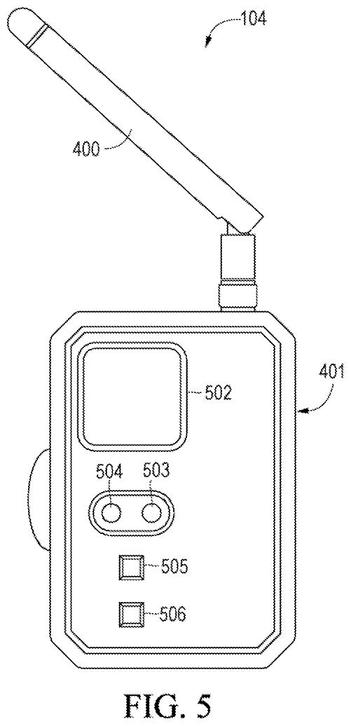

FIG. 5 is an exemplary handheld sound device as is shown in FIG. 1.

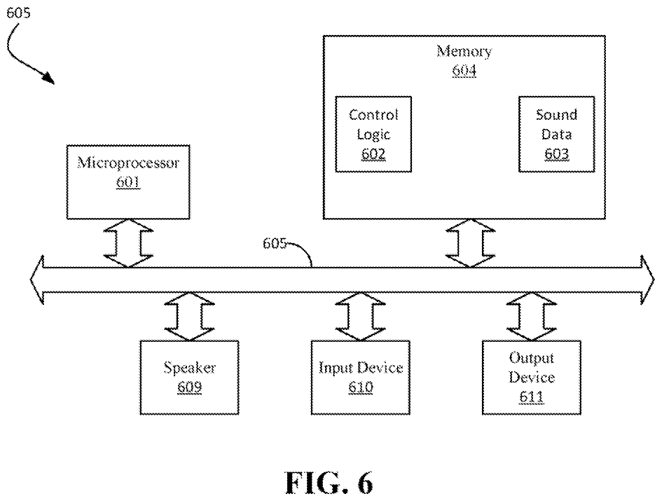

FIG. 6 is an exemplary microcontroller of the handheld device such as is shown in FIG. 5.

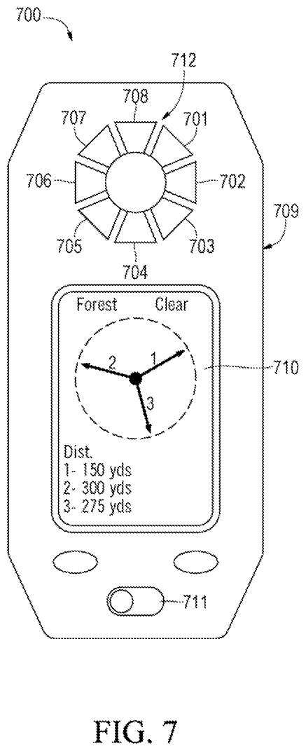

FIG. 7 is another embodiment of a system for enhancing location of game in a field.

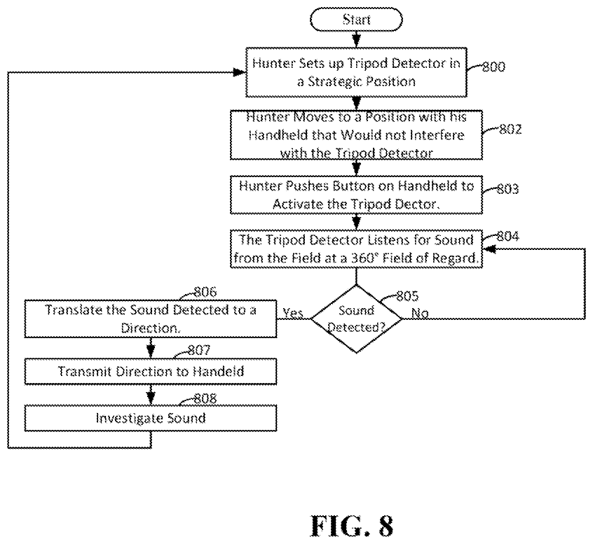

FIG. 8 is a flowchart depicting exemplary architecture and functionality of a system for enhancing the location of game in a field.

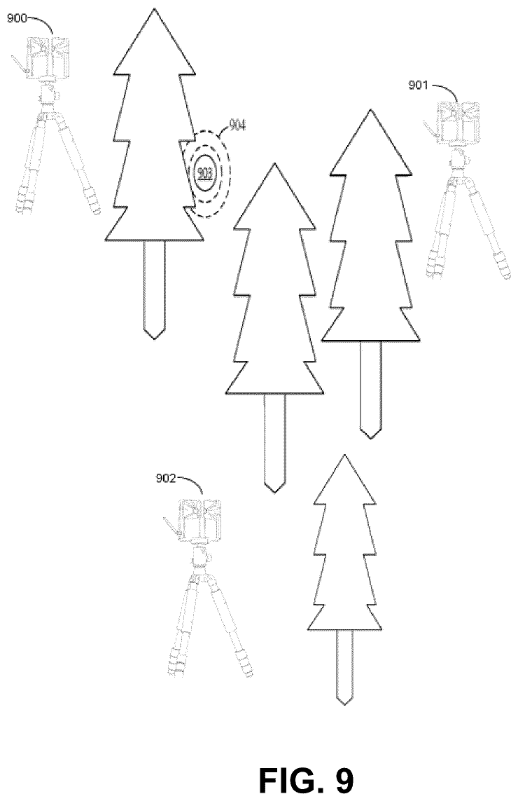

FIG. 9 is a diagram of a plurality of sound detectors as shown in FIG. 2 triangulating a sound to determine the sound's location.

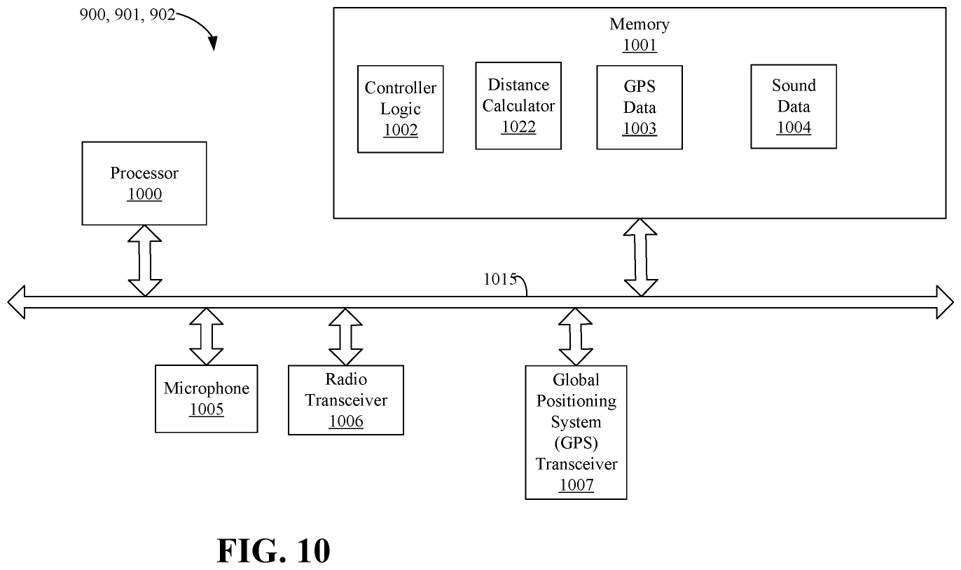

FIG. 10 is a block diagram of another exemplary sound detector as shown in FIG. 2.

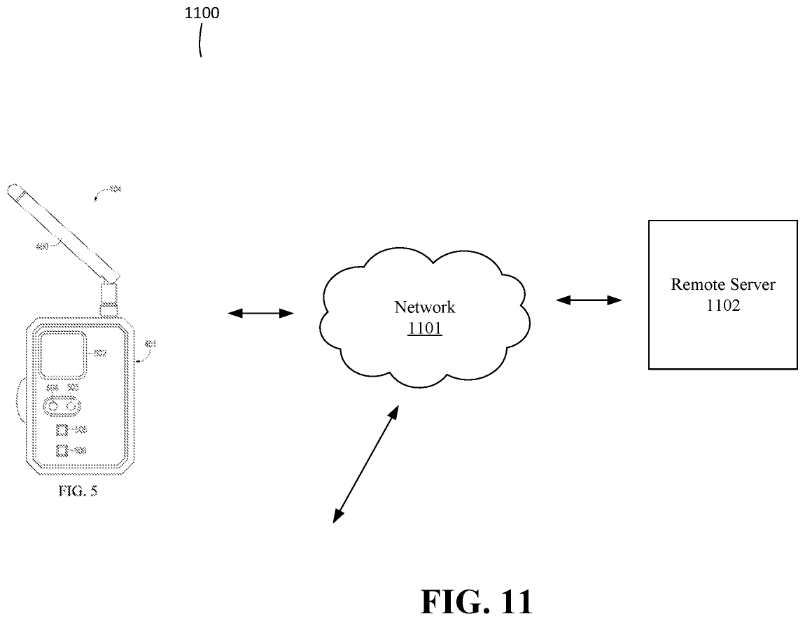

FIG. 11 is a block diagram of a sound detection system in accordance with an embodiment of the present disclosure.

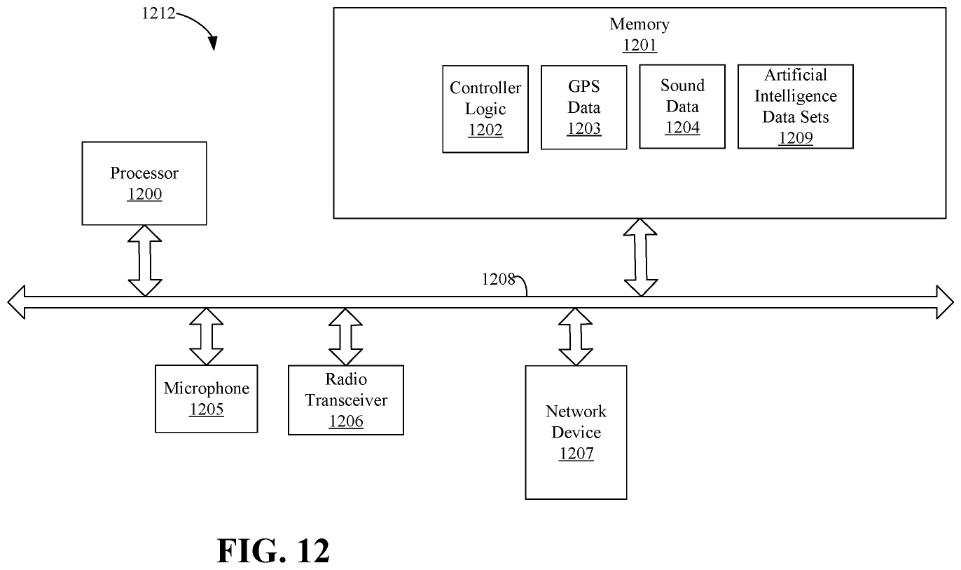

FIG. 12 is a block diagram of an exemplary remote server as shown in FIG. 1.

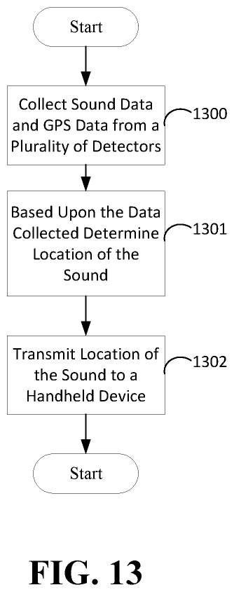

FIG. 13 is a flowchart exhibiting exemplary architecture and functionality of triangulation by the remote server shown in FIG. 13.

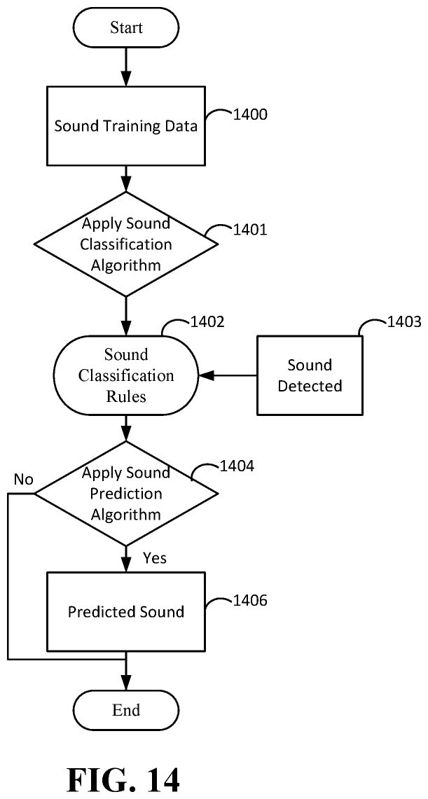

FIG. 14 is another flowchart exhibiting exemplary architecture and functionality of machine learning by the remote server shown in FIG. 13.

### DETAILED DESCRIPTION

The present disclosure relates to systems and methods for enhancing the location of game in a field. In particular, the system for enhancing location of game in the field includes a detection device that has a 360° range of detecting sound. The detection device is placed in the field, and it listens for sound in the field.

The system for enhancing the location of game in the field further comprises a handheld device used by the hunter. Thus, if sound is detected, the detection device communicates with the handheld device. The handheld device communicates to the hunter via a graphical user interface (GUI) the location of the sound, e.g., South, North, Southeast, Southwest, Northeast, Northwest, etc. field. FIG. 1 is a depiction of the system 100 for enhancing the location of game in a

The system 100 for enhancing the location of game in a field comprises a detector 101. The detector 101 comprises a plurality of microphones (not shown) that detect sound in a 360° field of view.

Further, the system 100 for enhancing location of game in the field comprises a handheld device 104. The handheld device 104 is used by a hunter 105.

In operation, a sound source 102 creates a sound. Note that a sound source 102 may be a type of animal, e.g., deer or turkey. The sound waves 103 travel through the foliage 106 or obstacle.

The sound waves 103 travel toward the detector 101. One of the plurality of microphones detects the sound waves 103.

In response, the detector 101 translates the sound waves 103 into a direction. In the example provided in FIG. 1, the soundwaves 103 are traveling from the Northeast zone. So, the detector 101 translates the sound waves 103 in data indicative of the Northeast.

Thus, the detector 101 transmits data indicative of the Northeast zone to the handheld device 104. Upon receipt, the handheld device 104 displays the direction to the hunter 105 via a GUI.

Upon receipt of the direction provided in the GUI, the hunter 105 moves his location to the Northeast zone. Upon moving, the hunter 105 will be in a better position to kill the prey.

FIG. 2 is an exemplary embodiment of a detector 101 according to an exemplary embodiment of the present disclosure.

The detector 101 comprises a base 100. The base is made up of three legs 202-203. In this regard, the base is a tripod. The legs 202-204 coupled to a body 211 of the detector 101. The body of the detector 101 comprises actuators 210 and 211 for positioning a head 204 of the detector.

The head 204 is fixedly coupled to a connector member 209. The head 204 comprises a plurality of microphone cones 207 and 208. The cones 207 and 208 aid the microphone in picking up sound waves 103 (FIG. 1).

At the vertex of each cone is coupled a microphone (not shown). The microphones 205 and 206 detect sound waves 103 from its direction. For example, if the microphone is facing Northeast, the microphone will pick up sound waves 103 from the Northeast.

FIG. 3 is a cross-sectional view of the head 204. In this regard, the head 204 comprises six (6) microphones 305-310. Each microphone has a cone 206, 207, and 301-304, respectively. The cones 206-207, and 301-304, respectively, aid the microphone in detecting sound waves 103 (FIG. 1).

In the embodiment shown in FIG. 3 there are six microphones 305-310. However, there may be more or fewer in other embodiments. With six microphones 305-306, the 360° acoustical field is covered by each of the microphones 305-310 acoustically covering 60°. That is microphone 305 covers the North, Northeast, and East zones, the microphone 306 covers the Northeast, East, and Southeast zone, the microphone 307 covers the Southeast, and South zones, the microphone 308 covers the South, Southwest, and West zone, the micro 309 covers the Southwest, South, and Northwest zone, and microphone 310 covers the Northwest and North zones.

Thus, regardless of where the sound originates, one or more of the microphones shall receive the sound waves 103. The head 204 further comprises a microcontroller. The microcontroller receives data from one or more of the microphones. Depending on which microphone(s) transmitted the data, the microcontroller comprises logic store in memory that performs acoustical analysis to determine, based upon which microphone originated the data, where the sound occurred.

Note that the microcontroller further comprises a Bluetooth transceiver. Thus, upon determination of where the sound originated, the logic transmits data indicative of the location to the handheld device 104.

FIG. 4 depicts an exemplary embodiment of the microcontroller 311 depicted in FIG. 3. As shown by FIG. 4, the microcontroller 311 comprises control logic 402, distance attenuation calculator logic 412, and sound data 403 all stored in memory 300.

The control logic 402 generally controls the functionality of the microcontroller 311, as will be described in more detail hereafter. It should be noted that the control logic 402 can be implemented in software, hardware, firmware, or any combination thereof. In an exemplary embodiment illustrated in FIG. 4, the control logic 401 is implemented in software and stored in memory 404.

Note that the control logic 402, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The distance attenuation calculator logic 412 generally controls determining a distance from the detector 101 of a sound. at least one bus. It should be noted that the distance attenuation calculator logic 412 can be implemented in software, hardware, firmware, or any combination thereof. In an exemplary embodiment illustrated in FIG. 4, the distance attenuation calculator logic 412 is implemented in software and stored in memory 404.

Note that the distance attenuation calculator logic 412, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the microcontroller 312 depicted by FIG. 4 comprises at least one conventional processing element 401, such as a digital signal processor (DSP) or a central processing unit (CPU), that communicates to and drives the other elements within the microcontroller 312 via a local interface 405, which can include at least one bus. Further, the processing element 401 is configured to execute instructions of software, such as the control logic 402 and the distance attenuation calculator logic 412.

FIG. 5 is a handheld device 104 in accordance with an embodiment of the present disclosure. The handheld device 104 comprises an antenna 400 for receiving data from the detector (FIG. 2).

The handheld device 104 comprises a microcontroller (not shown). The microcontroller comprises control logic and data stored in memory (not shown). Further, the microcontroller comprises a Bluetooth transceiver. The handheld device 104 allows for 1000 feet range fast wireless transmission. In one embodiment, the signal travels at 2.4 Gigahertz radio frequency signal allowing for fast data transfer between the handheld device 104 and the detector 101.

The handheld device 104 comprises a light 504 for indicating that the handheld 104 is on. That is, when the handheld device 104 is on, the light 504 may turn green. It may turn other colors in other embodiments. Further, the handheld device 104 comprises a light 503 for indicating battery level. That is, if the battery of the handheld device 104 is low, the light 503 activates. In one embodiment, it turns red.

The handheld device 104 comprises a pushbutton 505. Pushbutton 505 is selected to retrieve data. The handheld device 104 further comprises pushbutton 506 that when selected, resets the device.

The handheld device 104 further comprises a display 502. The display 502 may be used to display a map, for example, for showing locations of sound detectors or locations of sounds, as described further herein.

FIG. 6 depicts an exemplary embodiment of a microcontroller 605 of a handheld device 104 depicted in FIG. 4. As shown by FIG. 6, the microcontroller 605 comprises control logic 602 and sound data 603 all stored in memory 600.

The control logic 602 generally controls the functionality of handheld device 104, as will be described in more detail hereafter. It should be noted that the control logic 602 can be implemented in software, hardware, firmware, or any combination thereof. In an exemplary embodiment illustrated in FIG. 6, the control logic 602 is implemented in software and stored in memory 604.

Note that the control logic 602, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the microcontroller 605 depicted by FIG. 6 comprises at least one conventional processing element 601, such as a digital signal processor (DSP) or a central processing unit (CPU), that communicates to and drives the other elements within the handheld device 104 via a local interface 605, which can include at least one bus. Further, the processor 601 is configured to execute instructions of software, such as the control logic 602.

The microcontroller 605 further has an input device 610. The input device 610 can be in the form of pushbuttons, for example button 505 for collecting data.

The microcontroller 605 has output device 611. The output device 611 may be in the form of flashing light-emitting-diodes (LED) on the handheld device 104. Another output device may be a speaker 609. The speaker may be able to repeat the sounds heard in the field and allow for better location of game.

During operations, a hunter 105 (FIG. 1) sets up the detector 204 (FIG. 2) in an area where the hunter 105 suspects there may be game. Note that the hunter 105 can move the detector 204 up and/or down or laterally depending upon the hunter's needs. The hunter 105 stands quietly in the bush or otherwise to avoid startling the game. Note that the handheld 204 has an activation footage of 1000 feet, so if the hunter 105 does not go outside the 1000 feet he can still transmit and receive signals from the detector 204.

Once the hunter 105 activates the detector 204 by pressing the pushbutton 505, the detector begins collecting data. Note that in one embodiment the detector 204 inherently knows direction via an internal compass. Thus, when the hunter 105 hears a sound or sees a direction indicator on the GUI, he can walk toward the sound to get a better shot of the game.

FIG. 7 is another embodiment of a system 700 for enhancing the location of game in a field. The embodiment is a handheld unit comprising the components for detecting sound in a field.

The system 700 comprises a housing 709. The housing 709 may be made of plastic or some other type of durable material. The housing is an elongated octagon in shape.

On the front of the housing 709 at the top is an array 712 of microphones 701-708. Thus, the microphones' field of regard is 360°. That is, the system 700 can detect sound 360° about the system 711.

The system 700 comprises a graphical user interface (GUI). The GUI provides information to the hunter. For example, the clock-like arrows show the hunter the origination of the sound. It may also alert the hunter to how far the object that made the sound is located. For example, sound I was detected in the Northeast and is 150 yards.

Finally, the system 700 comprises an on/off switch 711. When a hunter desires to use the system to track prey, he may flip the system on using the switch 711.

FIG. 8 is a depiction of exemplary architecture and functionality of the system of the present disclosure.

Initially, a hunter sets up a tripod detector in a strategic position in step 800. For example, the hunter may know from experience where a group of deer congregate. Thus, the hunter may set up the tripod close to that area where the group of deer congregate.

In step 801, to avoid scaring off prey, the hunter may move to a position where the handheld may not interfere with the tripod detector.

In step 802, the hunter presses the button on the handheld that starts receiving microphone data. The tripod detector listens for sound from the field of regard of 360°.

If a sound is detected in step 804, the system translates the sound detected to a direction in step 805. The system transmits direction to the handheld device in step 806, and the hunter can then investigate the sound in step 807.

If no sound is detected in step 804, the hunter may continue to try to listen in the field of regard. However, the hunter may also move the tripod detector to another location and try again.

FIG. 9 is a diagram of a plurality of sound detectors 900-902 set some distance apart in a remote setting. Each of the sound detectors 900-902 are substantially mechanically and electrically like the sound detector 101 (FIG. 2).

In operation, each of the sound detectors 900-902 detect a sound 903 via sound waves 904 that propagate to each of the sound detectors 900-902. Upon receipt of the sound waves, each detector records the sound received and transmits the sound received to a handheld device described further herein. Along with data indicative of the sound, each sound detector 900-902 transmits its global positioning system (GPS) location.

Each sound detector 900-902 comprises a microcontroller (not shown). The microcontroller is described herein with reference to FIG. 10.

FIG. 10 is a block diagram of another exemplary microcontroller 1020 that may be implemented in the sound detectors 900-902 of FIG. 9. As shown by FIG. 10, the microcontroller 1020 comprises control logic 1002, distance attenuation calculator logic 1021, and sound data 1004, and global positioning data 1003 all stored in memory 1001.

The control logic 1002 generally controls the functionality of the microcontroller 1020, as will be described in more detail hereafter. It should be noted that the control logic 1002 can be implemented in software, hardware, firmware, or any combination thereof. In an exemplary embodiment illustrated in FIG. 10, the control logic 1002 is implemented in software and stored in memory 1001.

Note that the control logic 1002, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The distance calculator logic 1022 generally controls determining a distance from the detector 900-902 to a sound. It should be noted that the distance attenuation calculator logic 1022 can be implemented in software, hardware, firmware, or any combination thereof. In an exemplary embodiment illustrated in FIG. 10, the distance calculator logic 1022 is implemented in software and stored in memory 404.

Note that the distance calculator logic 1022, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the microcontroller 1020 depicted by FIG. 10 comprises at least one conventional processing element 1000, such as a digital signal processor (DSP) or a central processing unit (CPU), that communicates to and drives the other elements within the microcontroller 1020 via a local interface 1015, which can include at least one bus. Further, the processor 1000 is configured to execute instructions of software, such as the control logic 1002 and the distance calculator logic 1022.

Note that the distance attenuation calculator logic 1022, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

Further stored in memory 1001 is sound data 1004. In one embodiment, the sound data 1004 is data indicative of sounds detected by the microcontroller 1020. Further, memory 1001 stores GPS data 1003. The GPS data 103 is obtained from a GPS transceiver 1007. The GPS data 1003 may comprise data indicative of where the detector 900-902 is located.

The microcontroller 1020 further comprises a radio transceiver 1006. The radio transceiver 1006 is any type of device for receiving or transmitting data via radio waves.

Further, each microcontroller 1020 comprises at least one microphone 1005. The microphone 1005 detects sounds within an environment of the sound detector 900-902.

FIG. 11 is a block diagram of a sound detection system 1100 in accordance with an embodiment of the 104 disclosure. The sound system 1100 comprises a handheld device 104 that communicates with a remote server 1102 via a network 1101. Note that in one embodiment, the sound detection devices 700 (FIG. 7) or the sound detection devices 101 may communicate directly with the remote server 1100.

In this regard, during operation, the handheld device 104 receives sound and location data from each of the detectors 900-902. The handheld device 104 may display a location of each detector 900-902 and/or a sound detected and/or predicted location of each sound by each of the detectors 900-902.

Upon receipt, the handheld device 104 transmits data indicative the sound detected, the predicted location of the sound and the location of each detector 900-902 to the remote server 1102 via the network 1101.

Based upon the data received, the remote server 1102 identifies the sound and the location of the sound. The remote server 1102 transmits data indicative of the identify of the sound and the location of the sound to the handheld device. The handheld device 104 is configured to display the location of the sound to the display device, for example on a map.

FIG. 12 is a block diagram of the exemplary remote server 1102 as shown in FIG. 12. As shown by FIG. 10, the remote server 1202 comprises control logic 1202, GPS data 1203, and sound data 1204, distance data 1210 and artificial data sets 1209 all stored in memory 1201.

The control logic 1202 generally controls the functionality of the remote server 1202, as will be described in more detail hereafter. It should be noted that the control logic 1202 can be implemented in software, hardware, firmware, or any combination thereof. In an exemplary embodiment illustrated in FIG. 12, the control logic 1202 is implemented in software and stored in memory 1001.

Note that the control logic 1202, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the remote server 1102 depicted by FIG. 11 comprises at least one conventional processing element 1200, such as a digital signal processor (DSP) or a central processing unit (CPU), that communicates to and drives the other elements within the remote server 1102 via a local interface 1208, which can include at least one bus. Further, the processor 1100 is configured to execute instructions of software, such as the control logic 1202.

Further stored in memory 1201 is sound data 1204. In one embodiment, the sound data 1004 is data indicative of the sounds detected by the microcontroller 1220 and transmitted to the remote server 1202. Further, memory 1201 stores GPS data 1203 that is indicative of the location of each of the detectors 900-902 (FIG. 9).

The remote server 1202 further comprises a network device 1206. The network device 1206 receives data from the handheld device 700 (FIG. 10) via the network 1101 (FIG. 11).

Further, the remote server 1202 comprises artificial intelligence data sets 1109. The artificial intelligence data sets 1209 is a collection of sound data that is used to train a model. The artificial intelligence data sets 1209 teach the algorithms of the control logic 1102 how to make a sound prediction, i.e., determine a source of a sound detected.

Note that any type of artificial intelligence may be used including, but not limited to artificial narrow intelligence, artificial general intelligence, artificial superintelligence, reactive machines, limited memory, theory of mind or self-aware.

Further, for each detector 900-902 the remote server 1202 receives distance data 1210. The distance data 1210 is data indicative of the distance of each detector 900-902 from a sound source 903 (FIG. 9).

In operation, the control logic 1202 is configured to determine the exact location of a sound source 903 through triangulation. That is, the control logic 1202 uses data indicative of the location of each detector 900-902, the distance of each detector 900-902 from a sound source 903 and determines an estimated location of the sound source 903.

The remote server 202 then transmits the estimated location of the sound source to the handheld device 700 (FIG. 11). In one embodiment, the handheld device 700 may display a map to an operator showing the location of the detectors 900-902 and the location of the sound source 903.

In another embodiment, the control logic 1202 may also determine what generated the sound. In this regard, the control logic 1202 is trained via use of the artificial intelligence data sets 1109 on different sounds.

Thus, during operation, the control logic 1202 may employ algorithms learned via the artificial intelligence data sets 1209 to identify a source of a sound. In addition, as data indicative of new and different sounds are received, the control logic 1202 may learn, via for example machine learning, new sounds.

After the control logic 1202 identifies the source of a sound, the control logic 1202 transmits data indicative of the identity of the source to the handheld device 700. In response, the handheld device 700 may display data indicative of the identity of the sound to the operator.

FIG. 13 is a flowchart of exemplary architecture and functionality of the control logic 1002 (FIG. 10). In step 1300, the control logic 1002 collects sound data and GPS data from a plurality detectors 900-902 (FIG. 9).

In step 1301, based upon the data collected, each detector 900-902 determines a distance to the sound. In step 1302, the control logic 1002 transmits data indicative of the distance to the sound and its GPS coordinates to the handheld device 700 (FIG. 11).

FIG. 14 is a flowchart exhibiting exemplary architecture and functionality of machine learning by the remote server 1102 shown in FIG. 11.

In step 1400, the control logic 1202 is trained based upon the sound training data. In step 1401, the control logic 1202 classifies each learned algorithm.

In step 1402, a data indicative of a sound is received by the remote server 1102. Applying the sound classification rules in step 1403, the control logic 1202 applies a sound prediction algorithm to the sound. The sound predicted may be correct in step 1403, and the control logic 1202 transits the identity of the sound to the handheld device 700. If not, the process ends.

What I claim is:

1. A sound detection system, comprising:
at least one sound detection device, the sound detection device configured for placement in an environment to detect sounds in the environment;
at least one handheld device, the handheld device configured for receiving data indicative of a sound in the environment detected by the sound detection device;
a processor configured for identifying the sound and notifying an operator of the handheld device what produced the sound.

2. The sound detection system of claim 1, wherein the handheld device is remote from the sound detection device.

3. The sound detection system of claim 1, further comprising a remote server, the handheld device in communication with the remote server via a network.

4. The sound detection system of claim 3, wherein the remote server is configured to identify the sound and what produced the sound based upon artificial intelligence.

5. The sound detection system of claim 4, wherein the artificial intelligence employed is artificial narrow intelligence, artificial general intelligence, artificial superintelligence, reactive machines, limited memory, theory of mind or self-aware.

6. The sound detection system of claim 5, wherein the remote server is trained based upon artificial intelligence sound data sets.

7. The sound detection system of claim 6, wherein the remote server is further configured to learn new sounds and identify the new sound based upon the data indicative of the sound in the environment.

8. A sound detection method, comprising:
placing in an environment a sound detection device to detect sounds in the environment;
receiving data, via a handheld device, data indicative of a sound in the environment detected by the sound detection device;
identifying the sound;
notifying an operator of the handheld device what produced the sound.

9. The sound detection method of claim 8, further configured for receiving the data indicative of the sound remotely by the handheld device.

10. The sound detection method of claim 8, further comprising communicating by the handheld device with a remote server.

11. The sound detection method of claim 10, further comprising identifying, by the remote server, the sound and what produced the sound based upon artificial intelligence.

12. The sound detection method of claim 11, further comprising using, by the remote server, artificial narrow intelligence, artificial general intelligence, artificial superintelligence, reactive machines, limited memory, theory of mind or self-aware.

13. The sound detection method of claim 12, further comprising training the remote server upon artificial intelligence sound data sets.

14. The sound detection method of claim 14, further comprising learning new sounds, by the remote server.

15. The sound detection method of claim 15, further comprising identifying the new sound based upon the data indicative of the sound in the environment.

16. A sound detection system, comprising:
a plurality of sound detection devices, the sound detection devices configured for placement in an environment to detect sounds in the environment;
at least one handheld device, the handheld device configured for receiving data indicative of a sound in the environment detected by the sound detection devices;
a processor configured for determining a location of the sound based upon the data indicative of the sound received from the plurality of sound detection devices.

17. The sound detection system of claim 16, wherein the processor employs triangulation to determine the location of the sound based on the data indicative of the sound.

18. The sound detection system of claim 16, further comprising a remote server, the remote server configured for receiving the data indicative of the sound and determining a location of the sound.

19. The sound detection system of claim 16, wherein the remote device is configured to transmit location data indicative of location of the sound to the handheld device.

20. The sound detection system of claim 19, wherein the handheld device is further configured to display on a map a location of the sound based on the location data received from the remote server.

21. A sound detection method, comprising:
placing a plurality of sound detection devices in an environment to detect sounds in the environment;
receiving, by a handheld device, data indicative of a sound in the environment detected by the sound detection devices;
determining, by a processor, a location of the sound based upon the data indicative of the sound received from the plurality of sound detection devices.

22. The sound detection method of claim 21, further comprising triangulating the data indicative of the sound to determine the location of the sound based on the data indicative of the sound.

23. The sound detection method of claim 21, receiving, by a remote server, the data indicative of the sound and determining a location of the sound.

24. The sound detection method of claim 23, further comprising transmitting location data indicative of the location of the sound to the handheld device.

25. The sound detection method of claim 24, further comprising displaying on a map a location of the sound based on the location data received from the remote server.
